(19) United States
(12) Patent Application Publication
(10) Pub. No.: US 2026/0127253 A1
(43) Pub. Date: May 7, 2026

(54) SESSION REUSE IN DIFFERENT BROWSING CONTEXTS

(71) Applicant: SAP SE, Walldorf (DE)

(72) Inventors: Radoslav Ivanov Sugarev, Petrich (BG); Ivan Krastev Ikonomov, Sofia (BG)

(21) Appl. No.: 18/937,589

(22) Filed: Nov. 5, 2024

(51) Int. Cl. G06F 21/31

(52) U.S. Cl. CPC G06F 21/31

(57) ABSTRACT

The present disclosure relates to computer-implemented methods, software, and systems for reusing an existing user session in different browsing contexts. A request associated with a user can be received. The request can be for loading a first web application in an embedding context of a second web application, where a user is authenticated into the second web application at a first identity provider. A unique identifier can be generated to be assigned to a session for loading the first web application in a new browsing tab. The first web application can be triggered to be loaded into the new browsing tab by assigning the unique identifier to a current session of the user. The first web application can be refreshed into the embedded context of the second web application to search for a session associated with the generated identified and to reuse the session for rendering.

### TECHNICAL FIELD

The present disclosure relates to computer-implemented methods, software, and systems for access management and security.

### BACKGROUND

Software applications can provide services and access resources. Resources may be restricted to a limited number of users based on user rights and roles. Tokens, credentials, keys, or other suitable methods and tools can be used to authenticate requests to gain access to restricted resources. Applications can be provided in a shared context where one application can be accessible through another application. When a user requests access to a resource provided by an application, the user may be validated to determine whether the user is authorized to access the resource, which can happen through an identity provider.

### SUMMARY

The present disclosure describes mechanisms to implement an authentication mechanism that allows reuse of an existing user sessions in different browsing contexts.

In some instances, a method includes: receiving a request associated with a user to load a first web application in an embedding context of a second web application, wherein a user is authenticated into the second web application at a first identity provider; based on the received request, generating a unique identifier to be assigned to a session for loading the first web application in a new browsing tab; triggering to load the first web application into the new browsing tab by assigning the unique identifier to a current session of the user; and refreshing the first web application into the embedded context of the second web application to search for a session associated with the generated identified and to reuse the session for rendering.

In some instances, triggering to load the first web application can include: determining whether there is an existing session for the user at the first web application; and in response to determining that the existing session is the current session, assigning the current session with the unique identifier.

In some instances, triggering to load the first web application can include: determining whether there is an existing session for the user at the first web application. In response to determining that there is no existing session for the user at the first web application, the current session for the user at the first web application can be generated and session cookies including user credentials can be generated. The current session can be assigned with the unique identifier.

In some instances, it can be determined that there is no existing session for the user. Authentication of the user for the first web application at a second identity provider can be triggered. In some instances, the first identity provider and the second identity provider can be identical.

In some instances, the second identity provider can be identical to the first identity provider. When the authentication of the user is triggered at the first identity provider, an established session for the user when the user was authenticated for the second web application can be reused for authenticating the user for the first web application.

In some instances, the first web application can be associated with a plurality of application instances, wherein generating the unique identifier is performed by a first instance of the first web application. In some cases, generating the current session for the user can be performed at a second instance of the first web application different from the first instance.

The described subject matter can be implemented using a computer-implemented method; a non-transitory, computer-readable medium storing computer-readable instructions to perform the computer-implemented method; and a computer-implemented system including one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. The techniques of the present disclosure support a secure authentication mechanism that connects instances invoked by a user by reusing existing user sessions even in cases where a browser application limits the sharing of cookies between browsing tabs. If browsing contexts in a browser cannot share be shared, authentication is to be performed separately and also logging out on one browser tab (one context) would not lead to logging out on another tab (another context for the same application). Based on techniques of the present disclosure, the authentication implementation on the application side can be adjusted so that authentication in a given new browsing tab is triggered only when the application is accessed through an embedded context of another applications. Different sessions for the application can be interlinked through an identifier and they can have the same session cookies, so that the different sessions can be closed simultaneously.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 depicts an example architecture for managing reuse of sessions in different browsing contexts, according to an implementation of the present disclosure.

FIG. 2 is a flowchart illustrating an example of a computer-implemented method for managing reuse of sessions in different browsing contexts when an application is requested from an embedded context, according to an implementation of the present disclosure.

FIGS. 3A-3D are sequence diagrams illustrating an example of a computer-implemented method implementing an authentication mechanism employed by an application to reuse existing user sessions when an application is requested from an embedded context, according to an implementation of the present disclosure.

FIG. 4 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes mechanisms to implement an authentication mechanism that allows reuse of an existing user sessions in different browsing contexts and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Verifying an identity of an entity (e.g., a user, an application, or a service) to access a system, network, or application is known as authentication. It is performed through confirming that credentials (e.g., user password, a security token, biometrics, digital certificate, or other data) provided by the entity are accurate. For example, when a user logs into an application or website, session authentication (e.g., token-based authentication) can generate an identifier for the user session which can be used to verify further user requests. A new session ID can be generated and can be linked to an account of the user for each log-in to an application or website. The user's browser application can then receive the session identifier as a cookie that can be saved on the user's device. For each subsequent request of the user, the user's browser can use the session identifier to confirm the user's identity and to grant access to secured resources.

Websites and web applications can employ cookie-based authentication as a user authentication technique. For example, after an entity (e.g., a user or an application) logs in to a website with a browser, cookies can be used/stored in the browser and kept on a computing device. In some implementations, a cookie with a special identifier linked to an entity account can be created by the website when the entity logs in. The website may recognize and authenticate the entity without requesting a subsequent authentication by using the cookie at the website on subsequent visits.

In some implementations, applied security standards may restrict cookie authentication for applications such as web applications. In some instances, sharing of cookies between browser tabs in different contexts may be limited, and this may reflect the authentication mechanisms. In some instances, browsers can handle such limitation by implementing techniques to request access to cookies between contexts, for example, to request access to cookies that were issued in a context of a top-level application (a first party) by an embedded context associated with an embedded application in the top-level application. However, such techniques may be restricted in their applicability to all browsers and vendors, as well as style of applications. For example, such techniques may not be applicable when embedded applications work as add-ons and enable key features such as user tracking.

In accordance with the present implementations, a mechanism can be implemented for a web application, that is embedded in another web application, to reuse an existing user session of the user in the same web application. In some implementations, a browser application can have tabs where one of the tabs can load an application that would not share the same browsing context with another tab of the same browser that has loaded the same application as a top-level application when invoked from another application. In those cases, cookies issued in one of the contexts would not be visible to the other contexts, thus breaking an authentication mechanism that can depend on session sharing through session cookies.

In some implementations, a web application can be configured with an authentication configuration to handle reuse of sessions between different contexts without consideration for modifications of the authentication protocol that might be used by the application and how it can be used by other parties. In such cases, web applications can utilize session authentication to provide users with access to their accounts without requiring them to enter their passwords each time the users switch between pages or take other actions.

In some instances, a web application (e.g., a website) can be embedded within another web application (e.g., another website, for example, accessible through a hyperlink or other access navigation) that has a differing domain (context). For example, there can be different types of applications that can be embedded in another application (e.g., a third-party context). For example, such embedded application can be websites that provide specific services such as time management, web applications that are distributed as add-ons and enable key features (e.g., user tracking), web applications that can embed sites to reuse specific content, portal webpages that embed multiple sub-sites, etc.

In some implementations, changes to an authentication implementation of an application that is to be provided as an embedded application in another application's context can be defined to support the reuse of sessions between context, by connecting the sessions according to a generated unique identifier. When an application is accessed and loaded from an embedded context, authentication for the embedded application can be triggered in a new browsing tab. In some instances, an identifier can be used to correlate an existing session of a user in one browsing tab with the session for the same application in another browsing tab, where the application is to be loaded as an embedded application.

In some implementations, when a request to access an application is received in an embedded context and there are no session cookies available within that embedded context, an identifier can be generated for the embedded application. The identifier can be used as part of a request for authenticating the user for the embedded application, where the authentication process can be triggered in a new browsing tab. In this way, the identifier can be generated in the embedded context and can be provided to the new browsing tab content that is a different context. The identifier can link the two contexts and the sessions, thereof. Thus, when the authentication is executed at the new browsing tab or it is determined that a session is already existing, that new or previously existing session can be linked to the session in the embedded context. As such, upon authentication at the new browsing context, the embedded application can be loaded in the embedded context and a session associated with the generated identifier can be determined and reused so that the session cookies from the new browsing context can be used in the embedded context as well.

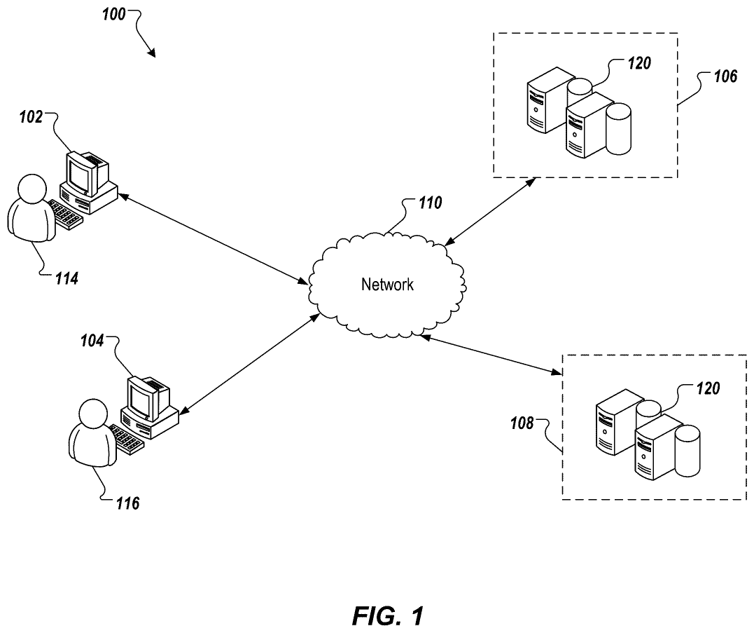

FIG. 1 depicts an example architecture 100 for managing reuse of sessions in different browsing contexts, according to an implementation of the present disclosure.

In the depicted example, the example architecture 100 includes a client device 102, a client device 104, a network 110, an environment 106, and an environment 108. The environment 106 and the environment 108 may be cloud environments. The environment 106 and the environment 108 may include corresponding one or more server devices and databases (e.g., processors, memory). In the depicted example, a user 114 interacts with the client device 102, and a user 116 interacts with the client device 104.

In some examples, the client device 102 and/or the client device 104 can communicate with the environment 106 and/or environment 108 over the network 110. The client device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the environment 106 includes at least one server and at least one data store 120. In the example of FIG. 1, the environment 106 is intended to represent various forms of servers including, but not limited to a web server, an application server, a proxy server, a network server, and/or a server pool. In general, server systems accept requests for application services and provides such services to any number of client devices (e.g., the client device 102 over the network 110) and other service requests, as appropriate.

In some instances, the environments 106 and 108 may host one or more client applications, application servers, and authorization servers to support execution of secure requests between the client applications and the application server. In some instances, the users 114 or 116 may access a client application through the network 110. The client application may be communicatively coupled with an application server. The application server may include application logic implemented to provide services and resources to end users.

In some instances, the environments 106 and 108 may host a portal web application that can embed multiple other web applications. For example, the portal web application can be considered as a portal website that provides tools and techniques to access resources provided by other web applications that are accessible through the portal website. In some instances, the portal web application can be configured to interact with users, where user can be provided with access to the portal web application upon authentication. The portal web application can be associated with a particular identity provided that handles authentication requests. In some instances, the authentication provider can be configured to run at the environments 106 or 108, or in some cases can be configured to run in another environment, such as a cloud environment, and be accessible to multiple applications at systems view the network 110 or other network.

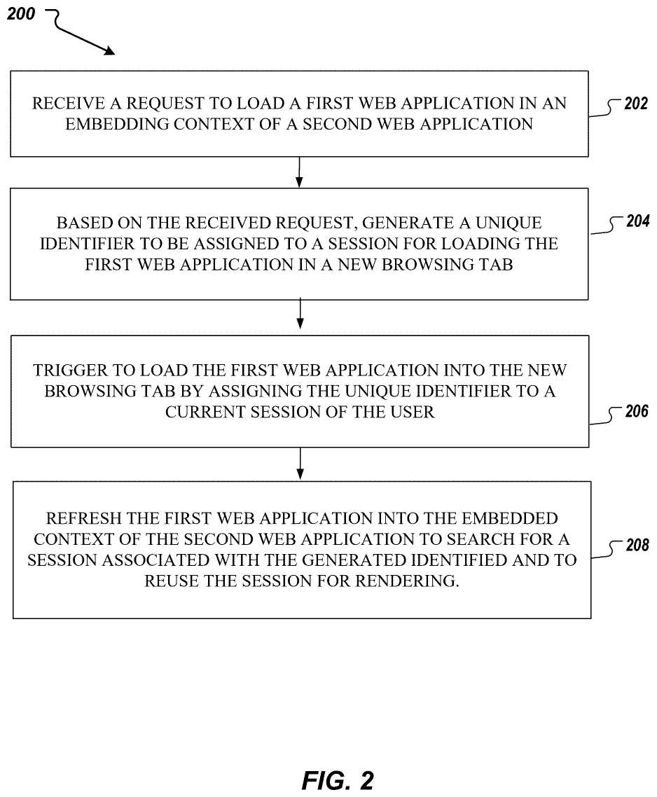

FIG. 2 is a flowchart illustrating an example of a computer-implemented method 200 for managing reuse of sessions in different browsing contexts when an application is requested from an embedded context, according to an implementation of the present disclosure. For clarity of presentation, the description that follows generally describes method 200 in the context of the other figures in this description. However, it will be understood that method 200 can be performed, for example, by any system, environment, software, and hardware, or a combination of systems, environments, software, and hardware, as appropriate. In some implementations, various steps of method 200 can be run in parallel, in combination, in loops, or in any order.

At 202, a request to load a first web application in an embedding context of a second web application is received. In some instances, the request can be received based on a user request to access the second web application. In some instances, the user is authenticated into the second web application at a first identity provider. From 202, method 200 proceeds to 204.

At 204, based on the received request, a unique identifier is generated. The unique identifier is generated to be assigned to a session for loading the first web application in a new browsing tab. From 204, method 200 proceeds to 204.

At 206, the first web application is triggered to be loaded into the new browsing tab by assigning the unique identifier to a current session of the user. In some instances, triggering to load the first web application in the new browsing tab can include determining whether there is an existing session for the user at the first web application, and in response to determining that there is an existing session, that session can be assigned with the unique identifier as generated at 204. In some instances, it can be determined that there is no existing session and, in that case, authentication for the user can be triggered. The generated sessions cookies for the new session can be provided through linking of the sessions based on the unique identifier to the embedded context where the first web application was triggered to be loaded and can be rendered after the authentication in the new browsing tab. The authentication can be performed at a respective identity provider designated for the first web application. That identity provider may or may not be identical to the provider used for authenticating at the second web application in which the first web application is embedded. From 206, method 200 proceeds to 208.

At 208, the first web application is refreshed into the embedded context of the second web application to search for a session associated with the generated identified and to reuse the session for rendering.

In some instances, the first web application can be executed with multiple instances, where, when loaded in an embedded context, a first instance of the first web application may be triggered to generate the identifier. When the first web application is loaded in a new browsing tab, the same or a different instance can be loaded. The loaded instance in the new browsing tab will be used to assign a session to the generated identifier. When the first web application is to be rendered at the embedded context, the assigned session can be searched based on the generated unique identifier and reused together with the shared session cookies for authentication.

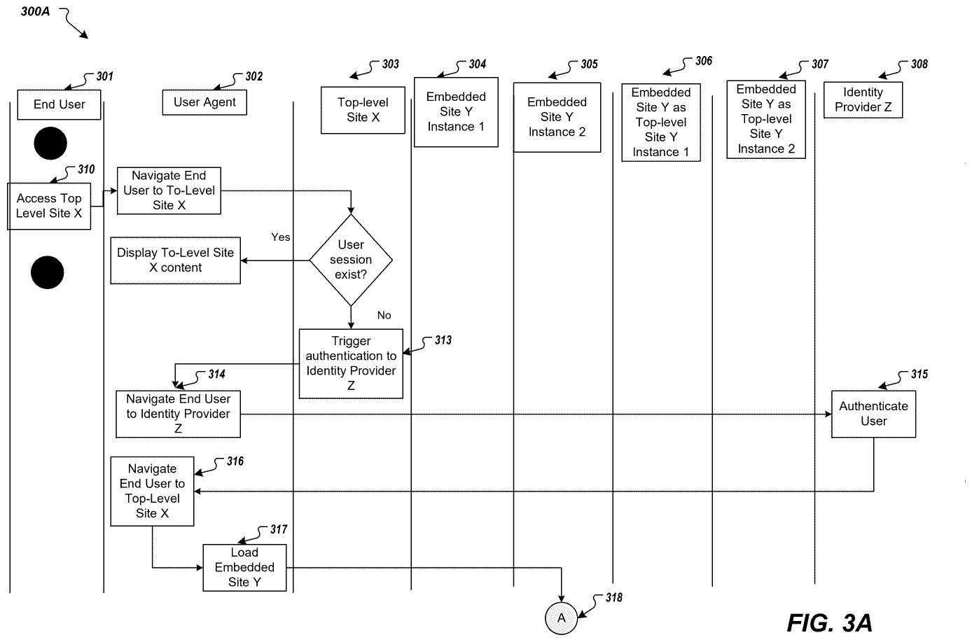

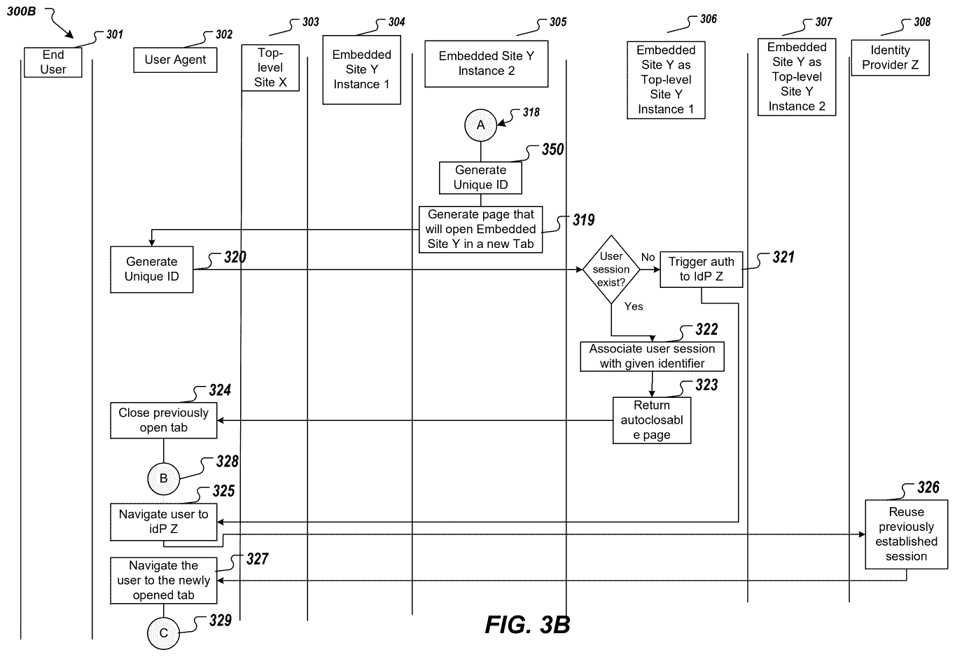

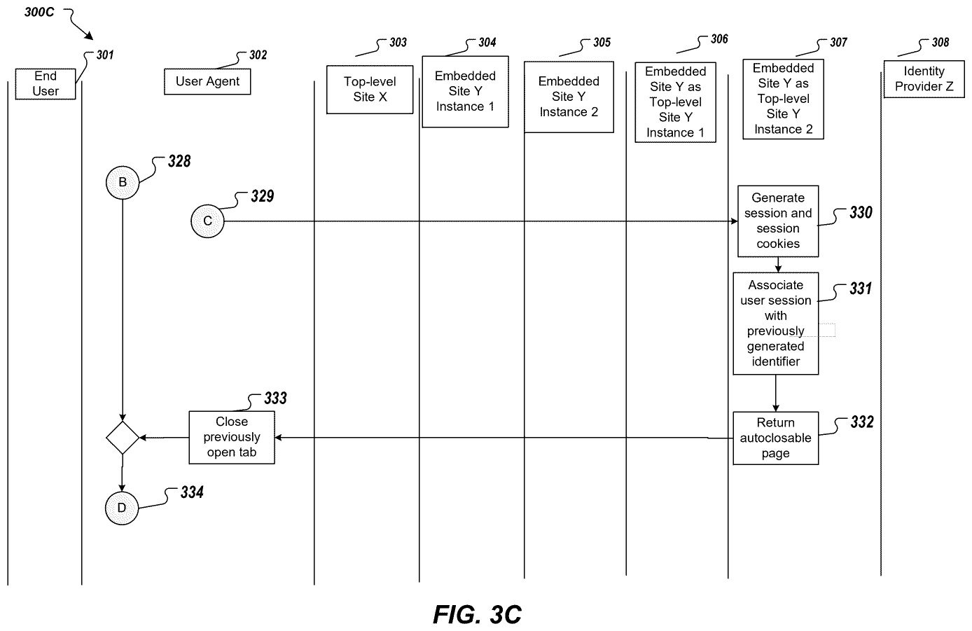

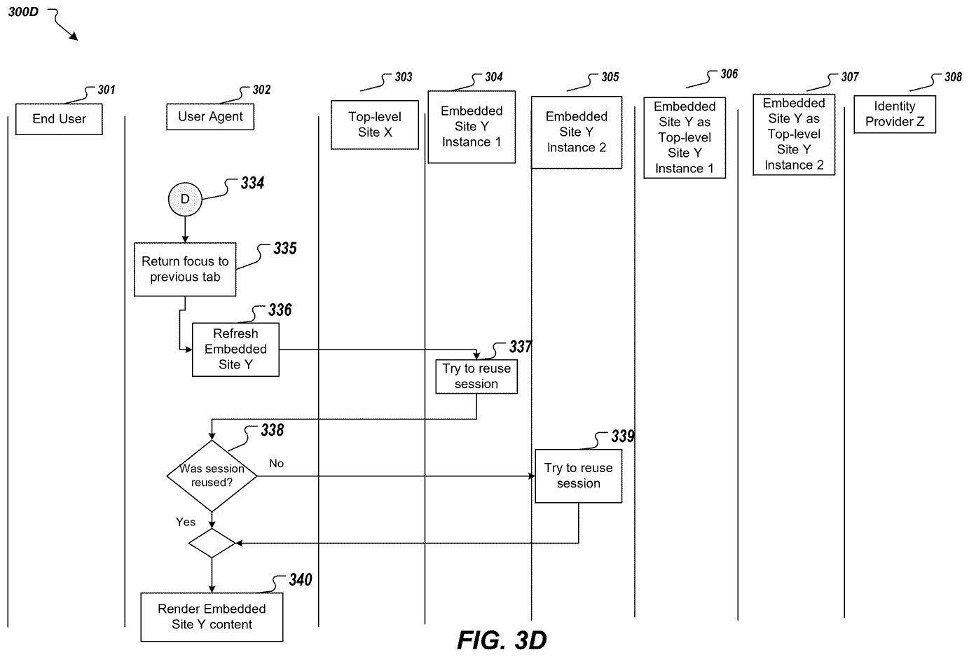

FIGS. 3A-3D are sequence diagrams illustrating an example of a computer-implemented method 300 (shown as a 300A at FIG. 3A, 300B at FIG. 3B, 300C at FIG. 3C, and 300D at FIG. 3D) implementing an authentication mechanism employed by an application to reuse existing user sessions when an application is requested from an embedded context, according to an implementation of the present disclosure. In some instances, the implemented method in the example 300 is associated with the usage of a unique identifier that is used to identify a user session in one browsing context that is link it the unique identifier so that the user session can be reused in another browsing context. In some instances, a top-level site X 303 is provided that embeds an embedded site Y (e.g., running with two instances 304 and 305). The embedded site Y 304 and 305 can be substantially similar to the first web application as described in relation to FIG. 2, and the top-level site X 303 can be substantially similar to the second web application as described in relation to FIG. 2. The embedded site Y can be configured to identify whether an instance the embedded site Y (304 or 305) was accessed in another browsing context and to link the session in the other browsing context to the embedded context in the top-level site X 303.

As shown in FIG. 3A-3D, the example 300 is associated with authenticating a user at an embedded site loaded from a top-level site. The embedded site, as well as the top-level site can run with one or multiple instances. While the present example shows that the embedded site Y is running with two instances 305 and 305, it should be understood that the embedded site can work with a single, three, four, or more instances. FIG. 3A-3D show a sequence of operations to render content of an embedded site loaded from a top-level site where the rendered embedded site Y 304 is running within a reused other session of the embedded site Y that was running when the embedded site Y was open as a top-level site (e.g., in the way that the top-level site X 303 is running as an application at the highest hierarchical level rendered in a browser tab).

In some instances, an end user 301 can access (at 310) the top-level site X 310, where a user agent 302 can navigate (at 311) the end user 301 to the top-level site X 303. In some instances, the user agent 302 is a browser where the top-level site X 303 is rendered in a browsing tab. In some cases, when the end user 301 is already logged into the top-level site X 303, the content of the top-level site X can be displayed at 312.

In some instances, if there is no user session for the user at the top-level site X 303, an authentication for the user 301 can be triggered (at 313) to the respective identity provider, i.e., Identity provider Z 308. In response to triggering the authentication at 313 at 313, the end user 301 can be navigated to authenticate (at 315) with the identity provider Z 308.

When the end user 301 is authenticated at the identity provider Z 308, the end user 301 is navigated (316) to the top-level site X 303 at the user agent 302. Since the top-level site X 303 has embedded sites such as the embedded site Y, those embedded sites are triggered to be loaded (317) in the user agent 302. In the present example, the embedded site Y runs with two instances—304 and 305, and the triggering of the loading can be associated with loading one of the instances, which in this case is embedded site Y 305 (Instance 2) as shown at A 308.

Once the second instance of the embedded site Y is triggered to be loaded at A 318, as shown in FIG. 3B, a unique identifier is generated for the user. The unique identifier is generated, at 350, to be assigned to a current (existing) session or to a new session that can be created for the user. In response to generating the unique identifier, a web page can be generated (at 319) to open the embedded site Y. The user agent 302 can open (at 320) a new tab, that is a new browsing context, where the embedded site is to be loaded. The opening of the new browser tab at 320 can be substantially the same as the triggering to load the first web application into the new browsing tab as described in relation to operation 206 of FIG. 2.

When the embedded site is triggered to be opened, one of the instances of the embedded site can be used, and in the example 300D as shown on FIG. 3D, that is the first instance 306. The first instance 306 is loaded in a new tab and it is determined whether there is a session existing for that user in the new tab. If there is no session existing for the user at the first instance 306 of the embedded site, authentication is triggered at 321. In some cases, the authentication can be executed through the same identity provider as the one associated with the top-level site X 303, or it can be different. The relevant identity provider for the authentication at the embedded site Y can depend on the configurations and authentications mechanisms implemented for the embedded site Y. The user agent 302 can navigate (at 325), the user 301 to the identity provide Z 308 to perform the authentication. Since the identity provider Z 308 is the provider used for authenticating the user 301 for the top-level site X 303 (as shown at 315 of FIG. 3A), the previously established session can be reused (at 326) for the embedded site Y. Upon successful authentication at 326, the user agent 302 can navigate (at 327) the user to the new browsing tab that is open (as instructed at 320). Once the user is navigated to the new open tab the user agent as shown at C 329 communicates with an instance of the embedded site Y, as shown in FIG. 3C. Since the embedded site Y runs with two instances (but can also run with only one or more than two), an instance of these two instances can be triggered to open in the new browsing tab. In the example, the second instance 307 of the embedded site Y is opened in the new browsing tab, where a session is generated (330) together with session cookies including the credentials of the end user 301 as provided by the identity provider Z 308. The generated user session is assigned (or associated) (at 331) with the generated unique identifier (at 350 of FIG. 3B) that was generated at the embedded site Y (instance 2) 305 when it was loaded in the embedded context of the browsing tab of the top-level site X 303. At 332, the page opened at the new browsing tab is automatically closed, and the user agent closes (333) the new browsing tab at 334, to proceed to D 334.

If, when a new browsing tab is opened for the embedded site Y as requested at 320, it is determined that there is an existing session for the user at the new browsing tab, the user session is assigned (322) with the unique identifier that is generated. In this way, no matter there is an existing session, or a new session will be created for the user in the new browsing context, the session will be assigned with the unique identifier as generated for the embedded site Y when opened in the embedded context. Upon assigning of the unique identifier to the existing user session, the page opened for the embedded site as a top-level site in the new browsing tab can be closed (at 323), and the previously opened tab by the user agent 302 for the embedded site Y as a top-level site can be closed, at 324, and through B 328, continues to D 334 of FIG. 3C.

As shown on FIG. 3D, once the user is authenticated in the new browsing tab and either an existing session or a new session of the user 301 is assigned with the unique identifier, the process of example 300 continues to D 334, where the user agent 302 returns the display focus (335) on the initial tab where the top-level site X 303 is open. At 336, the user agent 302 renders the top-level site X 303 and refreshes the embedded site Y at 336 to render the content of the embedded site Y. Upon refreshing of the embedded site Y, an instance of the embedded site Y is triggered to try to reuse a session on that instance that is associated with the generated unique identifier. In the example shown on FIG. 3D, the request first goes to Instance 1 of the embedded site Y 304, where it is searched (at 337) to find a session assigned with the unique identifier. Since there is no session on the Instance 1 of the embedded site Y 304, it is determined at 338, that there is no session that can be reused, and thus, the second instance, Instance 2 of the embedded site Y 305 is requested at 339 to search (to try to reuse it) for a session that is assigned with the unique identifier at 339. Since the second instance is the instance where the session was assigned to the unique identifier (at 322 of FIG. 3B or at 331 of FIG. 3C), the searching at 339 yields a result and thus, at 340, the content of the embedded site Y can be rendered at the user agent 302.

In some instances, the embedded site Y in the example 300 is capable of identifying whether it was accessed in an embedded context or at a top-level site context. If the request was made in an embedded context, the embedded site can respond to the request with a page that is to open in a new browsing tab. The new browsing tab can be considered as the context in which authentication for the embedded site can be triggered and executed. Table 1 presents example pseudo-code for such a page that can be provided as a response to a request to open the embedded site Y in an embedded context.

```
TABLE 1
<html>
  <body>
    <a id=”LINK-ID” href=”URL-TO-
APPLICATION?identifier=UNIQUE_IDENTIFIER” target=”_blank”></a>
  </body>
  <script>
    repeatedly_execute:
      if browser_tab_is_under_focus then:
            response = try_to_find_a_session_with_the_given_identifier(identifier)
        if response.is_session_successfully_reused then
          refresh_page_to_load_initially_requested_resource_with_reused_session
        end
      end
    press_the_link_with given_id(“LINK-ID”)
  </script>
</html>
```

In the example of Table 1, the page can include an automatic click instruction to open the new browsing context, however, it may be possible that such an instruction is obtained from an external entity, such as the user, or based on another event identification. In the example of Table 1, a unique identifier is appended as a query parameter to the uniform resource locator (URL) of the embedded site that is to be accessed. However, it may be possible that the unique identifier is provided to the top-level context of the embedded site in the new browsing tab through other means or tools.

In some instances, there can be different mechanisms that can be used to retain the unique identifier between the separate requests and actions. For example, one approach can be to request that the identity provider Z 308 sends back the unique identifier to the embedded site once the authentication is performed (at 326 of FIG. 3B). This exchange of the unique identifier between request can be supported by the authentication protocol that can be used by the identity provider Z 308. In the example of FIGS. 3A-3D, the exchange of the identifier can be performed through relying on the authentication protocol.

For example, another approach may be to keep the unique identifier in memory and employ some other mechanism to ensure that the request to open the embedded site in a new browsing tab would be sent to the same node or instance where the unique identifier is provided. Please note that in the example 300, the unique identifier is generated on instance 2 of the embedded site Y 305 and the request to open the embedded site Y at a new browsing tab is sent to instance 1 (to be opened in the top-level context 306). Regardless of the chosen implementation approach, once the session is successfully associated with the unique identifier, a response with a page requesting the end user 301 to close the tab and return to the initial tab might be returned. For example, that response can be send at 324 of FIG. 3B. Another approach can be to trigger the closing of the previously open tab automatically.

Once the focus is returned to the embedded site at 335, the execution of the script with the pseudo code as shown in Table 1 can return the focus on the initial browsing tab where the top-level site X 303 was initially loaded, and to start sending requests to the embedded site to try to determine the session associated with the identifier.

This execution corresponds to the example 300 of the process at steps 336 to 340 on FIG. 3D. In some instances, the unique identifier can be sent as a query parameter, as part of the request body, a header, or other options. Based on the associated session, a new session cookie(s) will be returned to the initial tab of the user agent 302. The cookie(s) that will be returned might have the same value or a different one. In some instances, if a server cannot have multiple identifiers for a single session, using the same value or the session will ensure that the session is the same and that any interaction with the embedded site can be synchronized with one another regardless of the context in which the changes to the session are made (e.g., because the session will be the same even if with different values). Using the same cookie(s) value may overcome challenges with the logout from the user agent, as regardless of the context in which the logout is triggered, the end user 301 will be logged out from all contexts. That may not be possible or at least be challenging if different cookie(s) value is used, and the sessions are not linked with one another, as in the present case with the use of the unique identifier. The successful reuse of the session might be indicated through a response received in the user agent, for example in the initially requested page that may be loaded.

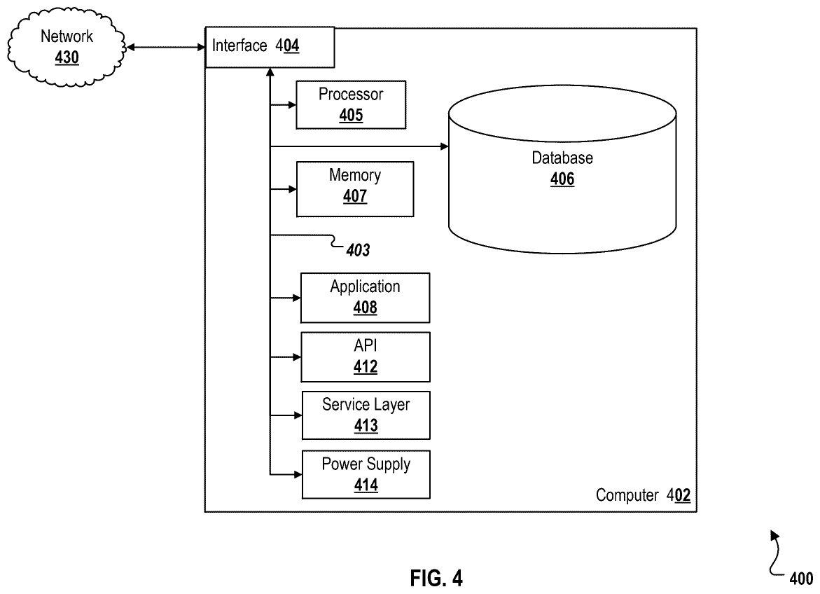

FIG. 4 is a block diagram illustrating an example of a computer-implemented System 400 used to provide computational functionalities associated with described algorithms, methods, functions, processes, flows, and procedures, according to an implementation of the present disclosure. In the illustrated implementation, computer-implemented system 400 includes a Computer 402 and a Network 430.

The illustrated Computer 402 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 402 can include an input device, such as a keypad, keyboard, or touch screen, or a combination of input devices that can accept user information, and an output device that conveys information associated with the operation of the Computer 402, including digital data, visual, audio, another type of information, or a combination of types of information, on a graphical-type user interface (UI) (or GUI) or other UI.

The Computer 402 can serve in a role in a distributed computing system as, for example, a client, network component, a server, or a database or another persistency, or a combination of roles for performing the subject matter described in the present disclosure. The illustrated Computer 402 is communicably coupled with a Network 430. In some implementations, one or more components of the Computer 402 can be configured to operate within an environment, or a combination of environments, including cloud-computing, local, or global.

At a high level, the Computer 402 is an electronic computing device operable to receive, transmit, process, store, or manage data and information associated with the described subject matter. According to some implementations, the Computer 402 can also include or be communicably coupled with a server, such as an application server, e-mail server, web server, caching server, or streaming data server, or a combination of servers.

The Computer 402 can receive requests over Network 430 (for example, from a client software application executing on another Computer 402) and respond to the received requests by processing the received requests using a software application or a combination of software applications. In addition, requests can also be sent to the Computer 402 from internal users (for example, from a command console or by another internal access method), external or third-parties, or other entities, individuals, systems, or computers.

Each of the components of the Computer 402 can communicate using a System Bus 403. In some implementations, any or all of the components of the Computer 402, including hardware, software, or a combination of hardware and software, can interface over the System Bus 403 using an application programming interface (API) 412, a Service Layer 413, or a combination of the API 412 and Service Layer 413. The API 412 can include specifications for routines, data structures, and object classes. The API 412 can be either computer-language independent or dependent and refer to a complete interface, a single function, or even a set of APIs. The Service Layer 413 provides software services to the Computer 402 or other components (whether illustrated or not) that are communicably coupled to the Computer 402. The functionality of the Computer 402 can be accessible for all service consumers using the Service Layer 413. Software services, such as those provided by the Service Layer 413, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 402, alternative implementations can illustrate the API 412 or the Service Layer 413 as stand-alone components in relation to other components of the Computer 402 or other components (whether illustrated or not) that are communicably coupled to the Computer 402. Moreover, any or all parts of the API 412 or the Service Layer 413 can be implemented as a child or a sub-module of another software module, enterprise application, or hardware module without departing from the scope of the present disclosure.

The Computer 402 includes an Interface 404. Although illustrated as a single Interface 404, two or more Interfaces 404 can be used according to particular needs, desires, or particular implementations of the Computer 402. The Interface 404 is used by the Computer 402 for communicating with another computing system (whether illustrated or not) that is communicatively linked to the Network 430 in a distributed environment. Generally, the Interface 404 is operable to communicate with the Network 430 and includes logic encoded in software, hardware, or a combination of software and hardware. More specifically, the Interface 404 can include software supporting one or more communication protocols associated with communications such that the Network 430 or hardware of Interface 404 is operable to communicate physical signals within and outside of the illustrated Computer 402.

The Computer 402 includes a Processor 405. Although illustrated as a single Processor 405, two or more Processors 405 can be used according to particular needs, desires, or particular implementations of the Computer 402. Generally, the Processor 405 executes instructions and manipulates data to perform the operations of the Computer 402 and any algorithms, methods, functions, processes, flows, and procedures as described in the present disclosure.

The Computer 402 also includes a Database 404 that can hold data for the Computer 402, another component communicatively linked to the Network 430 (whether illustrated or not), or a combination of the Computer 402 and another component. For example, Database 404 can be an in-memory or conventional database storing data consistent with the present disclosure. In some implementations, Database 404 can be a combination of two or more different database types (for example, a hybrid in-memory and conventional database) according to particular needs, desires, or particular implementations of the Computer 402 and the described functionality. Although illustrated as a single Database 404, two or more databases of similar or differing types can be used according to particular needs, desires, or particular implementations of the Computer 402 and the described functionality. While Database 404 is illustrated as an integral component of the Computer 402, in alternative implementations, Database 404 can be external to the Computer 402. The Database 404 can hold and operate on at least any data type mentioned or any data type consistent with this disclosure.

The Computer 402 also includes a Memory 407 that can hold data for the Computer 402, another component or components communicatively linked to the Network 430 (whether illustrated or not), or a combination of the Computer 402 and another component. Memory 407 can store any data consistent with the present disclosure. In some implementations, Memory 407 can be a combination of two or more different types of memory (for example, a combination of semiconductor and magnetic storage) according to particular needs, desires, or particular implementations of the Computer 402 and the described functionality. Although illustrated as a single Memory 407, two or more Memories 407 or similar or differing types can be used according to particular needs, desires, or particular implementations of the Computer 402 and the described functionality. While Memory 407 is illustrated as an integral component of the Computer 402, in alternative implementations, Memory 407 can be external to the Computer 402.

The Application 408 is an algorithmic software engine providing functionality according to particular needs, desires, or particular implementations of the Computer 402, particularly with respect to functionality described in the present disclosure. For example, Application 408 can serve as one or more components, modules, or applications. Further, although illustrated as a single Application 408, the Application 408 can be implemented as multiple Applications 408 on the Computer 402. In addition, although illustrated as integral to the Computer 402, in alternative implementations, the Application 408 can be external to the Computer 402.

The Computer 402 can also include a Power Supply 414. The Power Supply 414 can include a rechargeable or non-rechargeable battery that can be configured to be either user- or non-user-replaceable. In some implementations, the Power Supply 414 can include power-conversion or management circuits (including recharging, standby, or another power management functionality). In some implementations, the Power Supply 414 can include a power plug to allow the Computer 402 to be plugged into a wall socket or another power source to, for example, power the Computer 402 or recharge a rechargeable battery.

There can be any number of Computers 402 associated with, or external to, a computer system containing Computer 402, each Computer 402 communicating over Network 430. Further, the term “client,” “user,” or other appropriate terminology can be used interchangeably, as appropriate, without departing from the scope of the present disclosure. Moreover, the present disclosure contemplates that many users can use one Computer 402, or that one user can use multiple computers 402.

Described implementations of the subject matter can include one or more features as described throughout the application, alone or in combination. Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

In view of the above described implementations of subject matter this application discloses the following list of examples, wherein one feature of an example in isolation or more than one feature of said example taken in combination and, optionally, in combination with one or more features of one or more further examples are further examples also falling within the disclosure of this application.
Example 1. A computer-implemented method comprising:
   receiving a request associated with a user to load a first web application in an embedding context of a second web application, wherein a user is authenticated into the second web application at a first identity provider;
   based on the received request, generating a unique identifier to be assigned to a session for loading the first web application in a new browsing tab;
   triggering to load the first web application into the new browsing tab by assigning the unique identifier to a current session of the user; and
   refreshing the first web application into the embedded context of the second web application to search for a session associated with the generated identified and to reuse the session for rendering.
Example 2. The method of Example 1, wherein triggering to load the first web application comprises:
   determining whether there is an existing session for the user at the first web application; and
   in response to determining that the existing session is the current session, assigning the current session with the unique identifier.
Example 3. The method of Example 1 or Example 2, wherein triggering to load the first web application comprises:
   determining whether there is an existing session for the user at the first web application;
      in response to determining that there is no existing session for the user at the first web application,
         generating the current session for the user at the first web application, and
         generating session cookies comprising user credentials; and
   assigning the current session with the unique identifier.
Example 4. The method of Example 3, wherein in response to determining that there is no existing session for the user, triggering authentication of the user for the first web application at a second identity provider.
Example 5. The method of Example 4, wherein the first identity provider and the second identity provider are not identical.
Example 6. The method of Example 4, wherein the second identity provider is identical to the first identity provider, and wherein, when the authentication of the user is triggered at the first identity provider, an established session for the user when the user was authenticated for the second web application is reused for authenticating the user for the first web application.
Example 7. The method of any one of the preceding Examples, wherein the first web application is associated with a plurality of application instances, wherein generating the unique identifier is performed by a first instance of the first web application.
Example 8. The method of Example 7, wherein generating the current session for the user is performed at a second instance of the first web application different from the first instance.

What is claimed is:

1. A computer-implemented method, comprising:
receiving a request associated with a user to load a first web application in an embedding context of a second web application, wherein a user is authenticated into the second web application at a first identity provider;
based on the received request, generating a unique identifier to be assigned to a session for loading the first web application in a new browsing tab;
triggering to load the first web application into the new browsing tab by assigning the unique identifier to a current session of the user; and
refreshing the first web application into the embedded context of the second web application to search for a session associated with the generated identified and to reuse the session for rendering.

2. The method of claim 1, wherein triggering to load the first web application comprises:
determining whether there is an existing session for the user at the first web application; and
in response to determining that the existing session is the current session, assigning the current session with the unique identifier.

3. The method of claim 1, wherein triggering to load the first web application comprises:
determining whether there is an existing session for the user at the first web application;
in response to determining that there is no existing session for the user at the first web application,
generating the current session for the user at the first web application, and
generating session cookies comprising user credentials; and
assigning the current session with the unique identifier.

4. The method of claim 3, wherein in response to determining that there is no existing session for the user, triggering authentication of the user for the first web application at a second identity provider.

5. The method of claim 4, wherein the first identity provider and the second identity provider are not identical.

6. The method of claim 4, wherein the second identity provider is identical to the first identity provider, and wherein, when the authentication of the user is triggered at the first identity provider, an established session for the user when the user was authenticated for the second web application is reused for authenticating the user for the first web application.

7. The method of claim 1, wherein the first web application is associated with a plurality of application instances, wherein generating the unique identifier is performed by a first instance of the first web application.

8. The method of claim 7, wherein generating the current session for the user is performed at a second instance of the first web application different from the first instance.

9. A non-transitory, computer-readable medium storing one or more instructions executable by a computer system to perform one or more operations, comprising:
receiving a request associated with a user to load a first web application in an embedding context of a second web application, wherein a user is authenticated into the second web application at a first identity provider;
based on the received request, generating a unique identifier to be assigned to a session for loading the first web application in a new browsing tab;
triggering to load the first web application into the new browsing tab by assigning the unique identifier to a current session of the user; and
refreshing the first web application into the embedded context of the second web application to search for a session associated with the generated identified and to reuse the session for rendering.

10. The non-transitory, computer-readable medium of claim 9, wherein triggering to load the first web application comprises:
determining whether there is an existing session for the user at the first web application; and
in response to determining that the existing session is the current session, assigning the current session with the unique identifier.

11. The non-transitory, computer-readable medium of claim 9, wherein triggering to load the first web application comprises:
determining whether there is an existing session for the user at the first web application;
in response to determining that there is no existing session for the user at the first web application,
generating the current session for the user at the first web application, and
generating session cookies comprising user credentials; and
assigning the current session with the unique identifier.

12. The non-transitory, computer-readable medium of claim 11, wherein in response to determining that there is no existing session for the user, triggering authentication of the user for the first web application at a second identity provider.

13. The non-transitory, computer-readable medium of claim 12, wherein the first identity provider and the second identity provider are not identical.

14. The non-transitory, computer-readable medium of claim 12, wherein the second identity provider is identical to the first identity provider, and wherein, when the authentication of the user is triggered at the first identity provider, an established session for the user when the user was authenticated for the second web application is reused for authenticating the user for the first web application.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
receiving a request associated with a user to load a first web application in an embedding context of a second web application, wherein a user is authenticated into the second web application at a first identity provider;
based on the received request, generating a unique identifier to be assigned to a session for loading the first web application in a new browsing tab;
triggering to load the first web application into the new browsing tab by assigning the unique identifier to a current session of the user; and
refreshing the first web application into the embedded context of the second web application to search for a session associated with the generated identified and to reuse the session for rendering.

16. The system of claim 15, wherein triggering to load the first web application comprises:
determining whether there is an existing session for the user at the first web application; and
in response to determining that the existing session is the current session, assigning the current session with the unique identifier.

17. The system of claim 15, wherein triggering to load the first web application comprises:
determining whether there is an existing session for the user at the first web application;
in response to determining that there is no existing session for the user at the first web application,
generating the current session for the user at the first web application, and
generating session cookies comprising user credentials; and
assigning the current session with the unique identifier.

18. The system of claim 17, wherein in response to determining that there is no existing session for the user, triggering authentication of the user for the first web application at a second identity provider.

19. The system of claim 18, wherein the first identity provider and the second identity provider are not identical.

20. The system of claim 18, wherein the second identity provider is identical to the first identity provider, and wherein, when the authentication of the user is triggered at the first identity provider, an established session for the user when the user was authenticated for the second web application is reused for authenticating the user for the first web application.
